(19) United States
(12) Patent Application Publication
(10) Pub. No.: US 2023/0039780 A1
(43) Pub. Date: Feb. 9, 2023

(54) Rotatingly Drivable Grinding Media Mill for Obtaining Polyisoprene and/or Other Apolar Materials

(71) Applicants: Zoz GmbH, Wenden (DE); Fraunhofer-Gesellschaft zur Förderung der angewandten Forschung eingetragener Verein, München (DE)

(72) Inventors: Henning Zoz, Wenden (DE); Boje Müller, Rheine (DE); Dirk Prüfer, Münster (DE); Christian Schulze Gronover, Münster (DE)

(21) Appl. No.: 17/784,233

(22) PCT Filed: Dec. 8, 2020
(86) PCT No.: PCT/EP2020/085096

§ 371 Date: Jun. 10, 2022

(30) Foreign Application Priority Data
Dec. 10, 2019 (DE) 10 2019 133 787.9

(51) Int. Cl. B02C 17/02; B02C 17/18; B02C 17/24

(52) U.S. Cl. CPC B02C 17/02; B02C 17/1805; B02C 17/186; B02C 17/24; B02C 25/00

(57) ABSTRACT

The present invention relates to a grinding media mill (2) for obtaining polyisoprene and/or other apolar materials from raw plant materials, having a drum (4) which is peripherally closed and has a milling chamber (10) that is peripherally closed and located in the interior of the drum (4). The aim of the invention is to create a grinding media mill that enables careful processing of the raw plant materials, on the one hand, but is also variable in processing intensity and throughput time, on the other hand. This aim is achieved, according to the invention, in that the milling chamber (10) is divided into a plurality of sections along the rotation axis (6) by partitions arranged crosswise to the rotation axis (6), the partitions have passage openings through which the ground product mixture can pass from one section into an adjacent section, wherein the passage openings are sized such that they retain the grinding media located in a section, and the motor (8) is provided with an apparatus (38) by means of which the rotational speed of the drum (4) is variably adjustable.

The present invention relates to grinding media mill as well as a method for obtaining polyisoprene and/or other apolar materials from plant raw materials with a peripherally closed drum, drivable by a motor about an axis of rotation, with a milling chamber, embodied peripherally closed and located in the interior of the drum, into which grinding media can be introduced, a feed device arranged at a first end face for feeding a material mixture to be ground, comprised of solids and a liquid, through a rotary feedthrough, and a discharge device arranged at a second end face for discharging the material mixture to be ground that has been processed in the milling chamber.

From the publication DE 20 2014 100 640 U1 a grinding media mill of the aforementioned kind is known in the form of a ball mill whose drum is provided with rotary feedthroughs arranged at end faces in order to convey therethrough a material mixture to be ground, comprised of liquid and solid components, into the milling chamber and out again. Feeding of the material to be ground is realized by a pump. The ball mill can be operated in a continuous operation. The drum is caused to rotate by a drive. The balls contained in the milling chamber are also caused to move due to the rotational movement of the drum. Due to their movement, the balls comminute and crush the solids contained in the liquid and decompose it. Only a single milling chamber is provided which is delimited in conveying direction by a screen that is to remove coarse particles contained in the milling chamber upstream of the discharge device.

From the publication DE 10 2013 107 279 A1 it is known to obtain natural rubber from the root material of dandelion as plant raw material. Subsequent to a biological decomposition process, the root material is exposed to a mechanical comminution process that causes the root material to be comminuted and the natural rubber to be released. In this context, the natural rubber particles are to agglomerate. Subsequently, the biomaterial that is contained in the solution can be separated and isolated from the natural rubber agglomerates. It is mentioned only in passing that the mechanical comminution process can be realized by a rotating grinding media mill without there being any detail information to be found as to how such a grinding media mill is to be configured.

The publication U.S. Pat. No. 3,437,275 discloses a continuous method for wet milling of solid materials in a tube mill. It is described as a disadvantage of continuously operated tube mills with a plurality of sections divided from each other by partitions that the material to be ground collects in the sections when the openings in the partitions for further conveying the material to be ground are too small. It is proposed to solve this problem in that the material mixture to be ground is pressed with an excess gas pressure through the openings in the partitions of the sequential sections.

Natural rubber has as a main component a polymerizate of isoprene units, in particular the cis-1,4-polyisoprene. Nowadays, the natural rubber we primarily obtained from the latex of the rubber tree, which however is very labor-intensive and entails long transport routes to the processing facility. In addition, prices vary relatively greatly depending on weather and availability of the raw material in the cultivation countries.

In the following, only natural rubber is mentioned; this is intended to include the polyisoprene and/or other apolar resource materials that are to be separated from the remainder of the biomass of the plant raw materials. When obtaining natural rubber from plant raw materials, it is to be taken into account that it is a very sensitive material to be ground. In the grinding process, the plant raw materials are to be decomposed only to such an extent that natural rubber contained in the biomass separates from the remainder of the plant components and subsequently agglomerates in a coagulation process to larger flakes that can then be separated from the remainder of the plant components. However, the plant raw materials, when the grinding media act too intensively on the plant raw materials, can very quickly be comminuted so strongly that the natural rubber components can no longer be separated from the remainder of the plant components. Upon decomposition of the plant raw materials, there is only a very narrow window of time in which agglomerated natural rubber can be extracted from a material mixture to be ground before it is dissolved again due to a further processing. When obtaining natural rubber from plant raw materials, the intensity as well as the duration of processing are thus critical to the process.

A further problem in obtaining natural rubber from plant raw materials is to be seen in that the material to be ground is biological raw material that can exhibit a great variance so that the process technology is subjected to high requirements. For example, different species of plants may have to be processed respectively in pure form or in arbitrary mixtures with each other. Thus, not only dandelion plants contain components of natural rubber but also other plants such as, for example, sunflowers in their leaves or bananas in the banana peels. But even when only plants of one species are to be processed, they can be in different states of ripeness and decomposition, can be processed to different degrees by prior processing steps, grown to different strengths and/or contain different proportions of natural rubber. A grinding media mill that is to be used for obtaining natural rubber from plant raw materials must be adaptable to the different plant raw materials and their respective conditions.

It is the object of the present invention to provide a grinding media mill that, on the one hand, enables gentle processing of the plant raw materials, on the other hand, is however also variable in regard to processing intensity and processing time.

The object is solved by a grinding media mill of the aforementioned kind in that the milling chamber is divided along the axis of rotation into a plurality of sections by partitions arranged transversely to the axis of rotation, the partitions comprise passage openings through which the material mixture to be ground can pass from one section into a neighboring section, wherein the passage openings are sized such that they retain the grinding media contained in a section, and the motor is provided with a device by means of which the rotational speed of the drum can be variably adjusted.

The object is solved for a method of the aforementioned kind in that the method is performed with a grinding media mill that is configured according to one of the claims 1 through 19.

The grinding media mill can be operated preferably in a continuous operation in that a material mixture to be ground is fed to the drum continuously by the feed device, the material mixture to be ground passes through the various sections sequentially along the axis of rotation, and is discharged at the end by the discharge device from the drum. The material mixture to be ground contains at least partially a liquid with which the plant raw materials can be conveyed better through the drum and more uniformly distributed within the drum. The liquid is also required in order to enable the natural rubber to agglomerate with each other to flakes after its separation from the remainder of the biomass. The plant raw materials contained in the material mixture to be ground can have been washed and/or boiled and/or cut beforehand in order to facilitate the dissociation of the natural rubber from the remainder of the biomass. Such a pretreatment can be necessary dependent on the type of the employed plants in order to even be able to digest them. This possible pretreatment of the plant raw materials to be processed in the grinding media mill leaves however untouched the particularities of the grinding media mill as such.

Due to the continuous rotational movement of the drum, the grinding media in the respective sections are moved against each other the rotation of the drum and, following the rotational direction, moved again and again a bit. In that the grinding media during the continuous movement sheer past the plant raw materials present between the grinding media and rub thereon, they are decomposed. When the process parameters are adjusted from cascade mode into the cataract mode, the grinding media drop additionally from above onto the material mixture to be ground. Due to the impact force acting in this context on the plant raw materials, the latter are additionally decomposed. Due to the number of grinding media and the rotational speed of the drum, many impacts result correspondingly in a time interval that act on the plant raw materials contained in the sections and by which the cell structure of the plant raw materials is decomposed. In this context, the natural rubber that is contained in the plant raw materials is released and can float to the top and agglomerate in a flake-type manner in the liquid that forms a component of the material mixture to be ground. As agglomerated flakes, the natural rubber can be separated easily from the remainder of the components of the material mixture to be ground.

Due to the division of the milling chamber into a plurality of sections, sequential zones in which the plant raw materials can be processed with different intensity are provided in the direction of passage of the material mixture to be ground through the drum. Thus, it is possible to provide, for example, in the first section, an intensive processing for an initial decomposition, for example, by an appropriate furnishing of this section with corresponding bodies of material to be ground while the processing in the subsequent sections can be performed more gently in order to separate the natural rubber from the remainder of the plant components and to promote agglomeration. The drum as a whole comprises a length and a number of sections provided therein that is required for decomposing the plant raw materials to such an extent that the natural rubber agglomerates. The sections can be of different length in order to affect in this way the residence time of the plant raw materials in a section. For example, a longer section, in which no or only a few grinding media are present and in which the plant raw materials are substantially only moved and rinsed in the liquid of the material mixture to be ground, can adjoin a short section, in which the plant raw materials are more intensively acted on by heavy grinding media. The partitions can also be mounted so as to be movable along the axis of rotation in the drum in order to be able to change the length of the sections.

In that the partitions comprise passage openings through which the material mixture to be ground can pass from one section into a neighboring section, an automatic flow of the material mixture to be ground through the drum is provided. In particular by feeding a material mixture to be ground to one side of the drum, a flow is produced within the milling chamber with which the material mixture to be ground passes from a section arranged upstream to the next section that is located downstream, respectively, until it reaches the discharge device for discharging the material mixture to be ground that has been processed in the milling chamber. The passage openings can be sized such that they retain the grinding media located in a section but the material mixture to be ground can flow through the passage openings. However, individual or a plurality of passage openings can be designed such that they allow grinding media to pass through. It is also possible to embody passage openings in a partition that are differently sized and/or differently shaped. When passage openings that are permeable for the grinding media are arranged farther inwardly displaced toward the axis of rotation at a distance to the outer wall of the sections, the number of grinding media that actually pass through such a passage opening into the neighboring section remains minimal, in particular when in this section only a few grinding media are located. However, it may also be desired that the grinding media are conveyed through the milling chamber, for example, in a circulation in order to be able to control and affect the temperatures, the wear, damages. The passage openings can be designed to be adjustable in their size in order to be able to adapt them to different plant raw materials and their material properties, or throttle bodies can be placed onto the passage openings based on which differently sized or shaped passage openings result. Passage openings can be designed also as a type of screen in order to qualitatively select also larger components of the plant raw materials or contaminants from the material mixture to be ground. The passage openings affect with their shape, position, and size also the throughput quantity and throughput speed of the material mixture to be ground through the drum. They are sized, designed, and positioned such that a throughput speed, suitable for decomposition of the plant raw materials, is reached at which the natural rubber that has been agglomerated to flakes arrives in the last section of the drum or forms therein and can be discharged from there out of the drum.

Moreover, the motor is provided with a device by means of which the rotational speed of the drum can be variably adjusted. When the drum rotates faster, more impacts of grinding media on the plant raw materials in a time interval occur, at a lower rotational speed the number of impacts in the time interval decreases. The impacts that are exerted by the grinding media on the plant raw materials contained in the material mixture to be ground are also of different magnitude depending on the drum rotational speed. At a higher movement speed of the grinding media, higher kinetic energies are acting on the material mixture to be ground when the grinding media impact thereon. Due to the change of the drum rotational speed, the processing intensity of the plant raw material can thus be changed in a targeted fashion. When it is found that the natural rubber during the continuous processing of a material mixture to be ground agglomerates too early, the drum rotational speed can be reduced in order to stretch the agglomeration temporally. In contrast, the drum rotational speed can be accelerated when the natural rubber agglomerates too late. The device for rotational speed change can affect the power that is available for the motor in order to change in this way the rotational speed of the motor with which the drum is driven, or the transmission ratio of the motor rotational speed is changed by a gear box that is arranged between the motor and the drum.

In summary, it is possible with the grinding media mill according to the invention to design the decomposition of plant raw materials in the drum for obtaining natural rubber by a corresponding configuration and adjustment of the afore described variable components of the grinding media mill in such a way that the agglomerated natural rubber is found in the last section of the drum. The decomposition is adjustable gently enough in order to not destroy the natural rubber during the course of processing but also aggressive enough in order to extract the natural rubber from the remainder of the plant components to such an extent that it can agglomerate in the material mixture to be ground. In case of occurring variations in the plant raw materials, the grinding media mill can also be adjusted by changes of the changeable process parameters in such a way that even for changed plant raw materials the natural rubber can be retrieved in agglomerated form from the drum.

According to an embodiment of the invention, one or a plurality of partitions in the region of the axis of rotation comprise a cutout whose radius in at least one part of the circular arc covered by the cutout is larger than the radius of the axis of rotation in the region of the corresponding partition. Due to its design, the cutout forms for the section that it is limiting a type of overflow for the material mixture to be ground contained in this section which flows in the intermediate space between the rim of the cutout and the axis of rotation of the drum into the downstream positioned neighboring section of the milling chamber. The cutout can be configured rounded, in particular circular or oval. In case of an oval or other non-round configuration of the circumferential shape of the cutout, a batch-wise but thus stronger overflow in the region of the greatest radius of the cutout is provided which can provide in the neighboring section an improved turbulence of the material mixture to be ground compared to a more uniform overflow in case of a circular design of the cutout. A further advantage of a cutout in one or a plurality of partitions is the possibility to insert tools and/or sensors across a plurality of sections into the milling chamber along the axis of rotation and close to the axis of rotation from the end faces of the drum.

According to an embodiment of the invention, the drum comprises in the outer wall of one or a plurality of sections an opening which is permeable for the material mixture to be ground and which is adjoined in outward direction by a closed receiving chamber in which process tools can be arranged. Tools for washing, boiling and/or treating the material mixture to be ground and the plant raw materials contained therein are conceivable as process tools for the decomposition of the plant raw materials. The additional receiving chamber provides more space in order to be able to arrange therein corresponding process tools. From the exterior, the process tools which are arranged in or at the receiving chamber are more easily accessible in order to mount and service them. When the process tools are driven or when in this context a heater is concerned, the required energy for the operation of the process tools can be more easily supplied from the exterior to the corresponding process tool compared to guiding the energy supply through the milling chamber. The process tools can be steam nozzles or high-pressure nozzles that introduce a gas or a liquid into the milling chamber and/or into the receiving chamber whereby the plant raw materials are additionally decomposed. In case of some plant raw materials, the release of the natural rubber is possible only when the plant raw materials have been boiled beforehand. This can be done in the receiving chamber or with the process tools that are arranged in the receiving chamber. The receiving chamber can be configured as a part shell, half shell or a full shell that is fixedly connected to the drum and rotates with it or that is stationary, wherein then the transitions to the drum are sealed by seals against an uncontrolled escape of portions of the material mixture to be ground. The receiving chamber can be utilized to introduce liquid into the milling chamber or to pass it through the receiving chamber or to drain liquids from the milling chamber and/or the receiving chamber. The receiving chamber can serve also for separating sediments, for example, sand or other components of the material to be ground.

According to an embodiment of the invention, the sections are provided with a different quantity of grinding media and/or with grinding media of different sizes. The different sections make it possible to vary the processing intensity in that the sections are provided with different grinding media. In this context, grinding media of different size and/or weight and/or shape can be used in the individual sections. Also, the quantities of the grinding media in the sections can vary. When the characteristics of the plant raw materials to be processed changes during processing, this can be responded to by the removal of grinding media from one or a plurality of sections or the addition of grinding media into one or a plurality of sections. In this way, an adaptation of the processing intensity with which the plant raw materials are decomposed is possible. For example, for processing dandelion roots, banana peels, sun flower leaves, and the like, different grinding media filling plans for the individual sections can be provided in order to adapt the grinding media mill with a basic adjustment to the particularities of the plant raw materials to be respectively processed. The basic adjustment can then be fine-adjusted by the change of the number or the type of the grinding media filled into the sections.

According to an embodiment of the invention, a plurality of or all sections comprise supply and removal openings for supply or removal of grinding media. The supply and removal openings are advantageous in order to be able to adapt the fill of the individual sections with grinding media to a concrete need. The supply and removal devices can be combined with devices that enable a supply and removal even during continuing operation of the drum, for example, motor-controlled flaps through which, during the rotation of the drum, grinding media can be ejected from a section or filled into a section. Guide devices can be arranged upstream or downstream of the motor-controlled flaps by means of which the grinding media can be held, aligned, and supplied to or removed from a flap in an ordered manner.

According to an embodiment of the invention, the feed device comprises a drivable forced feeding action that is arranged upstream of and/or in the rotary feedthrough. The forced feed action can be embodied, for example, as a screw conveyor or a pusher working in a clocked fashion. The forced feed action is capable of even conveying a liquid, mushy or pasty material mixture to be ground, supplied to it and containing plant raw materials, in a clog-free manner into the milling chamber due to the forced conveyance with the auger or pusher plates. The quantity of material mixture to be ground that is fed by it to the milling chamber can correspond approximately to the quantity that is removed again at the discharge end of the drum from the milling chamber in the same time interval. However, it is also possible to remove individual fractions, for example, sand, sludge or other fractions, upstream of the discharge end from the milling chamber during flow of the material mixture to be ground therethrough. With the round or angular outer circumference of the conveying element of the forced feed action, for example, the auger or pusher plates, the forced feed action seals well a feed opening with a matchingly designed cross section against possible return flows of the material mixture to be ground. However, it is also prevented that grinding media enter the feed device and might impair or block thereat the material flow or damage components of the feed device.

According to an embodiment of the invention, the forced feed action is arranged coaxially to the axis of rotation of the drum. A forced feed action with a round outer circumference is particularly well suited to convey the material mixture to be ground through a rotary feedthrough into a rotatably driven drum. In case of a coaxial arrangement of the axis of rotation of the forced feed action to the axis of rotation of the drum, no offsets between these components result which would have to be sealed in a complex manner upon rotational movements of the forced feed action and of the drum.

According to an embodiment of the invention, the axis of rotation of the drum is positioned at an angle to the horizontal. In particular for a setting angle of the axis of rotation at which the axis of rotation descends downwardly from the feed device toward the discharge device, the intermediately located height difference provides an incline by means of which the material mixture to be ground, following the force of gravity, flows from sections located higher into sections located lower without requiring separate conveying aids for this purpose. The steeper the setting angle of the axis of rotation is selected, the faster the material mixture to be ground flows through the various sections of the conveying drum, and the flatter the setting angle is selected, the slower the material mixture to be ground flows from one section to the neighboring section. The drum can be supported in the grinding media mill in such a way that the setting angle of its axis of rotation is variably adjustable, for example, from a zero position into a setting angle at an incline of 10°. The adjustment can be realized in steps or continuously in order to increase or lower the flow rate of the material mixture to be ground in order to move the agglomeration of natural rubber within the drum in a direction upstream or downstream along the axis of rotation. This is possible, for example, when the drum is supported in a type of seesaw that is movable by a motor drive about an axis extending transversely to the axis of rotation, or the drum is held in a frame that at one of the two ends can be lifted or lowered. The positional adjustment can also be realized automatically by a control unit, in particular taking into consideration existing programming and/or sensor-supported evaluations of the continuing processing of a material mixture to be ground.

According to an embodiment of the invention, inner surfaces of one or a plurality of sections comprise no cylindrical basic shape. The inner surface of one or a plurality of sections can be configured, for example, conical or so as not to be plane-parallel to the axis of rotation of the drum in another way, for example, also stepped or in corrugated shape so that the inner surfaces are not aligned, at least not continuously, plane-parallel to the axis of rotation of the drum. Depending on whether the axis of rotation of the drum is aligned horizontally or at a setting angle to the horizontal, different flow rates result for the flow of the material mixture to be ground through the different sections. As a function of the setting angle of the axis of rotation of the drum relative to the horizontal, the conicity can lead to a downward slope, a horizontal plane, or an incline of the inner surface in the conveying direction. Based on this, flow accelerations, flow deflections, return flows or flow feeds within a section can be provided that enhance the conveying action, processing, and mixing of the material mixture to be ground. Upon adjustment of the setting angle of the axis of rotation, conicities in the inner surfaces of sections can also be overcompensated so that a downward slope in conveying direction leads to an incline in conveying direction or vice versa.

According to an embodiment of the invention, the drum is assembled of a plurality of pipe segments which are connected at flanges to each other along the axis of rotation of the drum. By means of the pipe segments, it is easy to produce a drum in which the natural rubber can be separated from the remainder of the components of the plant raw materials. The pipe segments can each form a section that are separated from the neighboring sections by partitions interposed between the pipe segments. The individual pipe segments can be easily individually configured. Pipe segments with different inner diameters of the sections or conically shaped inner surfaces can be easily produced. Also, installations such as flow paddles, stirring elements, lifting bars and the like or attachments such as feed and removal openings, flaps, sensor means, and the like can be mounted prior to assembly of the drum. The pipe segments can also be provided with linings and coatings as they are already known for grinding media mills, such as wear protection coatings, for example, of ceramic or other materials, sound dampening elements or thermal insulations. At the partitions, the rotary feedthroughs, and/or the conveying members of the feed device, corresponding attachments can also be easily realized prior to assembly of the drum.

According to an embodiment of the invention, the pipe segments comprise flange surfaces that are congruent relative to each other and are connected by connection elements to each other. By means of the flange surfaces that are congruent to each other and connection elements, different pipe segments can be assembled in an arbitrary sequence and orientation in an assembly set fashion. The partitions are also configured congruent to the flange surfaces so that they can form a part of the assembly set and can be inserted and mounted between neighboring pipe segments. Seals can be positioned between the flange surfaces in order to compensate tolerances. Intermediate flanges that are connected to each other can also form at their outwardly facing surfaces a running surface by means of which the rotating drum is supported on a roller bearing. The flange surfaces which are projecting past the pipe circumference of the drum can also be used to lock the drum during its rotation against an axial displacement in direction of the axis of rotation in that the flange surfaces are supported by a support element in direction of the axis of rotation of the drum.

According to an embodiment of the invention, the drum is supported on at least four rollers of which at least one roller is driven by a motor. Depending on the length of the drum, also more than four rollers can be provided for supporting the drum. The rollers enable the rotational movement of the drum about its axis of rotation. By means of the at least one motor-driven roller, the drum is caused to rotate. In this context, the motor which is driving a roller is provided with the device by means of which the rotational speed of the drum can be variably adjusted. A motor can also drive a plurality of rollers or several rollers are each provided with their own motor. When several motors are used, it is advantageous to synchronize the running of the motors with means that are known for this purpose in order to keep torsion forces in the drum and the frame on which the rollers are supported as minimal as possible. The rollers and the motors can be supported on a common frame that, in turn, can be movably supported according to one embodiment of the invention in order to change the spatial position of the axis of rotation of the drum.

According to an embodiment of the invention, the feed device for feeding a material mixture to be ground, comprised of solids and a liquid, comprises a feed container with which the material mixture to be ground or a portion of the material mixture to be ground can be metered to the feed device. The feed container serves for feeding the material mixture to be ground to the feed device. The plant raw materials of the material mixture to be ground can be already pre-processed for processing in the grinding media mill, for example, washed, cut and/or boiled. Due to this, the handling of the plant raw materials can have been changed in a disadvantageous manner when, for example, they are slushy or sticky. When the preprocessing action is realized in batch processes, a material batch is obtained, respectively, that is successively fed by the feed device into the milling chamber in the context of continuous operation of the grinding media mill. The feed container can then serve as a material buffer for the transition from the batch operation to the continuous operation. The feed container can be furnished in addition with feed aids in order to assist in the feed action, such as moving conveying members or conveying aids. The latter can be driven or controlled such that they only release from the feed container to the feed device a portion quantity of the material mixture to be ground, which portion has been pre-processed and/or is required in the context of the processing sequence in the milling chamber, or a fraction of the material mixture to be ground. Dry, solid, powdery, wet materials can be supplied as a fraction of the material mixture to be ground that is fed to the feed device via the feed container. However, a plurality of feed containers can also be provided that feed to the feed device a respective quantity of a part of the material mixture to be ground stored therein so that the material mixture to be ground is first admixed in the feed device.

According to an embodiment of the invention, the feed conduit for metering liquid and/or gaseous substances is connected to the feed device and/or to the feed container. The connected feed conduit makes it possible to actually make liquid the material mixture to be ground by a supplied liquid and/or make it more liquid. Also, liquid substances can be added to the material mixture to be ground, for example, acids, salts, bases or bacteria in aqua culture, by means of which the dissociation of the natural rubber in the milling chamber is favored. The supply of the liquid and/or of the gas can be realized also at high pressure and/or at a high temperature, for example, as hot steam, so that based thereon an additional decomposition of the plant raw materials is realized. The supply of a liquid or of a gas into the feed device can also serve to increase the pressure in the milling chamber, to increase the material throughput and the conveying speed of the plant raw materials through the milling chamber, to flush the milling chamber, or to clean the grinding media. The feed conduit can be controlled by a corresponding metering valve in such a way that it supplies the liquid and/or gaseous substances to the feed device continuously, in a clocked fashion, or as needed. The substances that are introduced by the feed conduit into the feed device can be moved through the feed conduit by known conveying aids such as pumps, compressors, and the like which can be arranged in a section of the feed conduit.

According to an embodiment of the invention, the grinding media mill comprises an electronic control unit which is connected to the device for changing the rotational speed of the drum and additionally to sensors that detect process-technological parameters of the grinding media mill and transmit them to the control unit, and to further actors by means of which process-technological parameters of the grinding media mill can be changed, wherein the control unit comprises a software that evaluates the sensor signals and the control unit controls the actors as a function of the evaluated sensor signals and/or of manual operating input of an operator. By means of the control unit, it is possible to not only control the rotational speed of the drum. In addition, sensor-monitored process parameters can be detected and evaluated. When the evaluation indicates a need for adaptation of the process-relevant parameters, they can either be only indicated by the control unit but also adjusted directly by the control unit by a corresponding control of the actors affecting the parameters. When the results of the evaluation of the sensor signals are only indicated, an operator can provide appropriate commands to the control unit by manual operating input to control the desired actors and adjust them in the desired manner. Thus, some or all of the process-relevant parameters, such as rotational speed of the drum, the speed and quantity of the supply of the material mixture to be ground and its composition by the appropriate metering of individual components of the material mixture to be ground, the angle position of the axis of rotation of the drum, flows of the material mixture to be ground in the drum, flushing processes, the milling of the natural rubber, the partial or complete filling or emptying of individual sections with grinding media, the temperature control in the milling chamber, and the like, can be adjusted in the desired manner by means of the control unit.

According to an embodiment of the invention, one or a plurality of sensors are arranged in the milling chamber for process monitoring. The sensors can be in particular one or a plurality of optical sensors that enable an optical control of the process progress and in particular of the work result at the downstream end of the milling chamber. With such a sensor arranged in the milling chamber, it is possible in particular to check whether and at which location in the milling chamber the natural rubber agglomerates. As optical sensors, for example, cameras are conceivable that transmit the recorded images from the milling chamber to an evaluation station outside of the milling chamber. A camera can be combined with an illumination means in order to illuminate the milling chamber at least in the region of viewing. The illumination means can illuminate the interior with light waves within the visible light spectrum but also outside of the visible light spectrum, for example, infrared light, wherein the camera is matched to the employed illumination means. The camera can also be designed as an infrared camera so that it enables an evaluation of the processing on the basis of a thermographic image or film. The evaluation station can be a monitor by means of which an operator has the possibility to evaluate the work result personally and optionally carry out changes regarding the adjustments of the grinding media mill. However, the evaluation station can also be a computer that has access to a software for automated image evaluation in order to issue an alarm when work results are recognized as faulty in the context of the ongoing evaluation and/or carry out software-supported automated changes regarding the adjustments of the grinding media mill. The sensors are preferably electronic sensors that are supplied with electric energy by wire or by means of an energy store that is attached to the drum. The electrical energy store has the advantage that the connected electrical sensor must not be supplied with electric energy by means of a rotary feedthrough.

According to an embodiment of the invention, the sensor or sensors are arranged adjacent to the axis of rotation in the milling chamber. With such a positioning of the sensor or sensors at a minimal distance to the axis of rotation, they are less exposed to the risk of becoming damaged by the grinding media or of becoming soiled by the material mixture to be ground. One or a plurality of sensors can also be arranged movably along the axis of rotation of the drum in the milling chamber so that one or a plurality of sections can be monitored by one or a plurality of sensors at different locations. For this purpose, a sensor can be fastened to a separate lance or to a carriage that is connected to the axis of rotation, with which lance or carriage the sensor is movable within the milling chamber. However, it is also possible to move one or a plurality of sensors by means of the carriage or lance from the exterior into the milling chamber and out of it again, for example, from the first or second end face and there in particular through the rotary feedthrough provided thereat.

According to an embodiment of the invention, flushing devices and/or feed conduits for supply of liquids are arranged at the lance or the carriage. The flushing devices can be used for cleaning the sensor or sensors but also the interior of the milling chamber. The liquids can also be processing liquids that enhance the dissociation and the agglomeration of natural rubber and that can be metered through the feed conduits in a targeted fashion into individual sections where they are needed.

According to an embodiment of the invention, control ports are present at the end face of the drum which is arranged at the downstream end. Through the control ports, an operator can check or a camera can record whether the natural rubber has agglomerated within the milling chamber and in particular in the region of the last section. The control ports enable a continuous control of the dissociation of the natural rubber in the context of the processing carried out in the grinding media mill without having to stop the rotational movement of the drum for this purpose.

According to an embodiment of the invention, the milling chamber has a conically tapering constriction at its end positioned downstream. Due to the conically tapering constriction, the filling level of the material mixture to be ground contained in this region in the drum becomes shallow. Due to the more shallow filling level, the natural rubber can float better to the surface of the material mixture to be ground and agglomerate with each other to flakes.

Further features of the invention result from the claims, the figures, and the subject matter description. All features and feature combinations which have been mentioned above in the description as well as the features and feature combinations mentioned in the following in the figure description and/or illustrated in the figures alone are usable not only in the respectively indicated combination but also in other combinations, but also individually.

The invention will now be explained with the aid of a preferred embodiment as well as with reference to the attached drawings in more detail.

It is shown in:

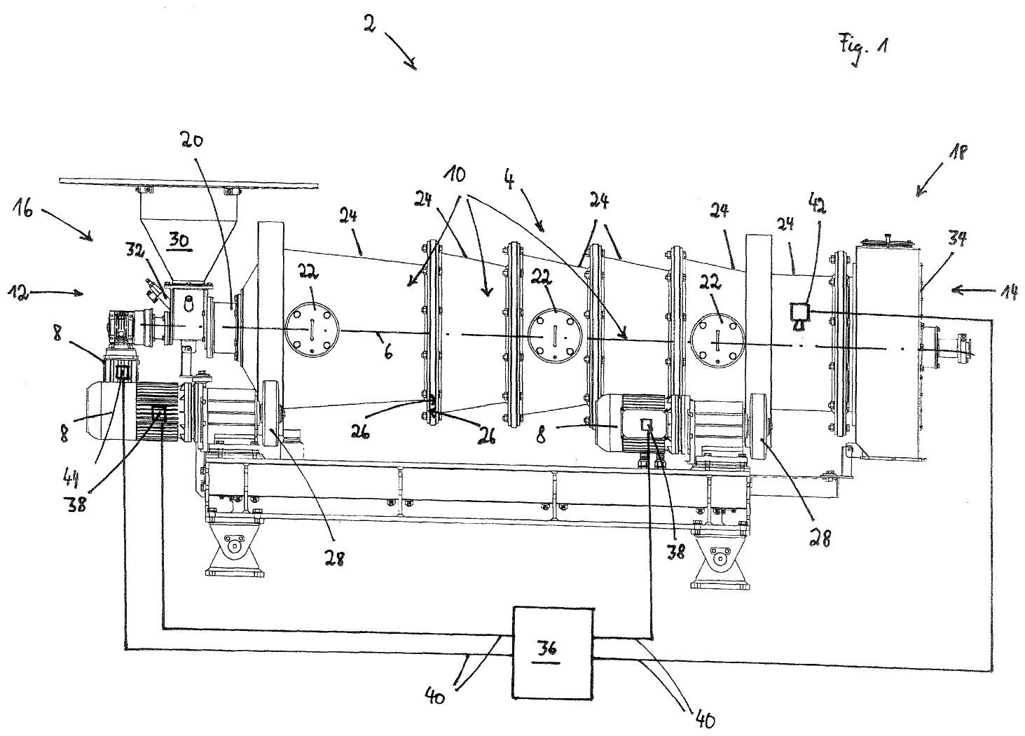

FIG. 1: a side view of a grinding media mill;

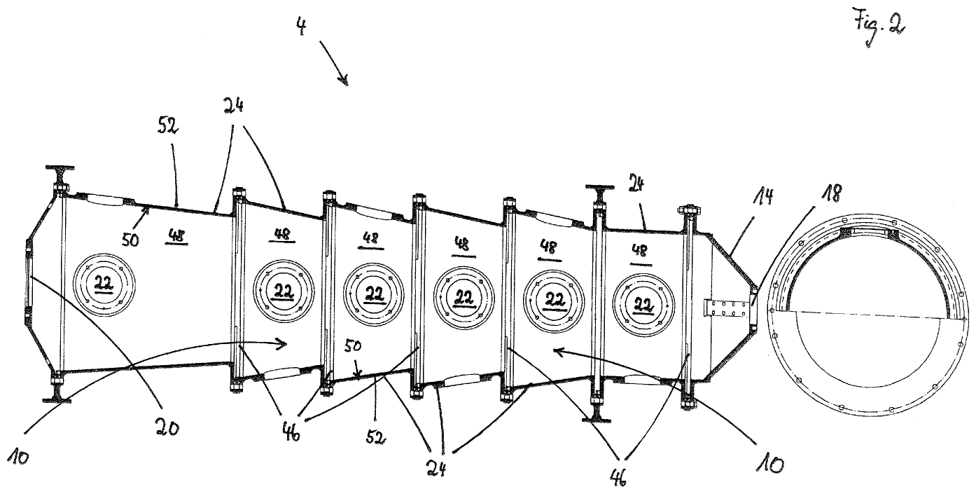

FIG. 2: a section view of the drum illustrated in FIG. 1;

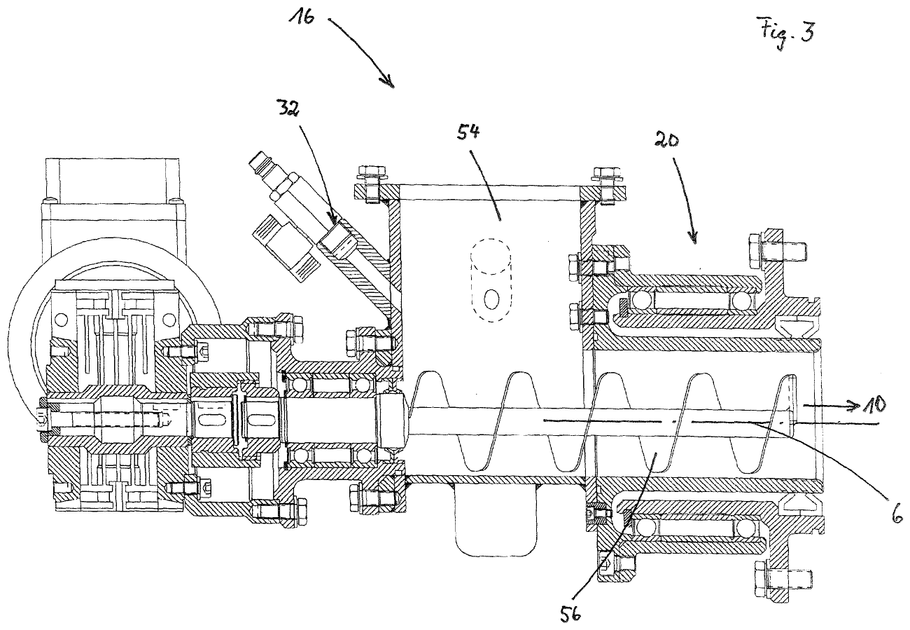

FIG. 3: an enlarged detail view of a feed device;

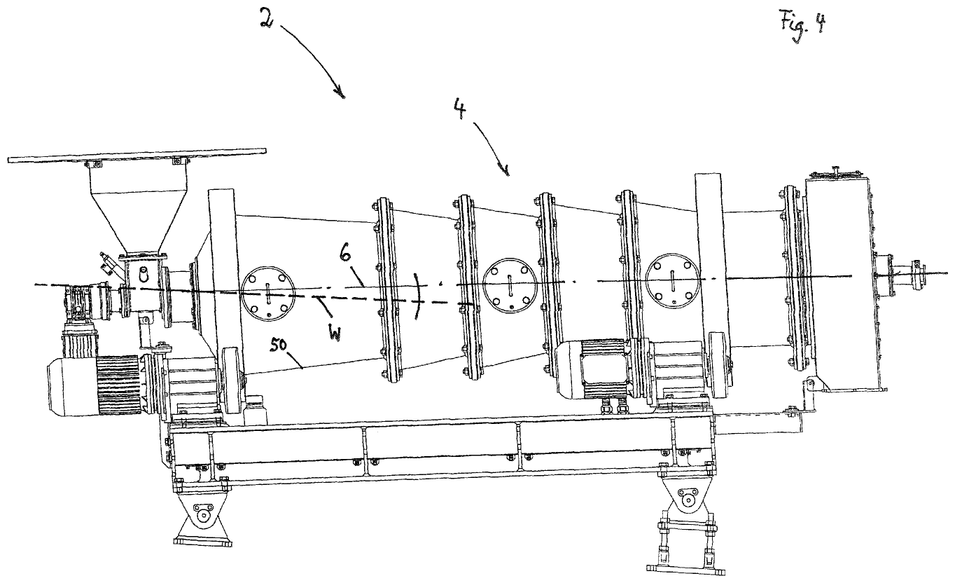

FIG. 4: a view of a drum with an ascending axis of rotation;

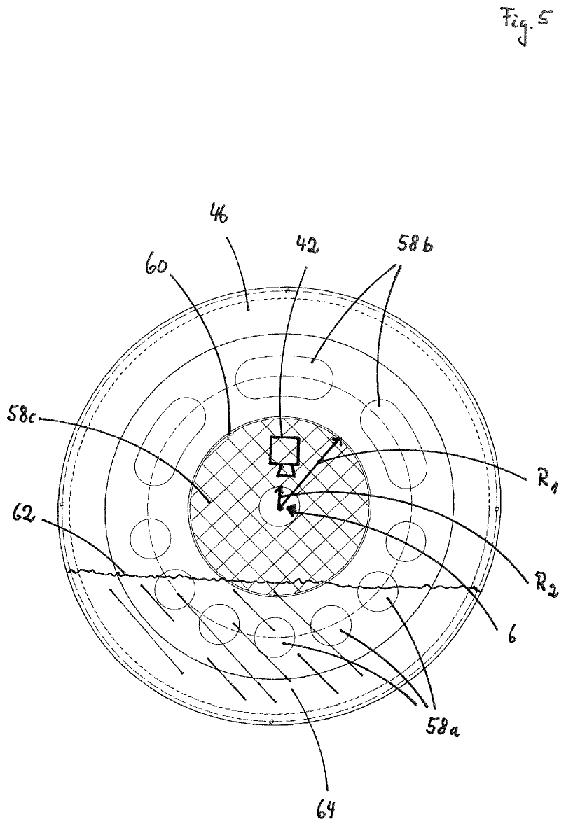

FIG. 5: a view of a partition;

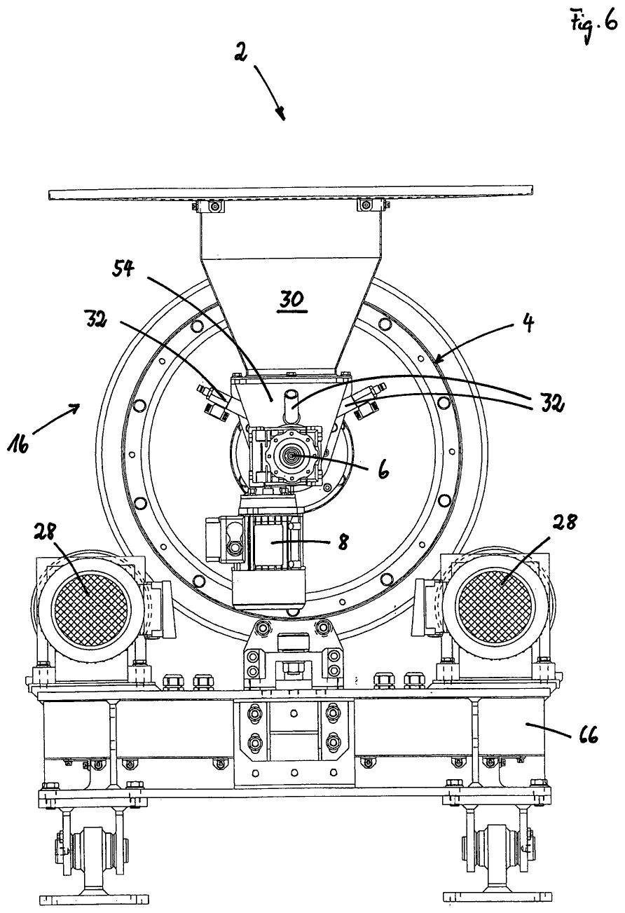

FIG. 6: a view of the feed side of the grinding media mill;

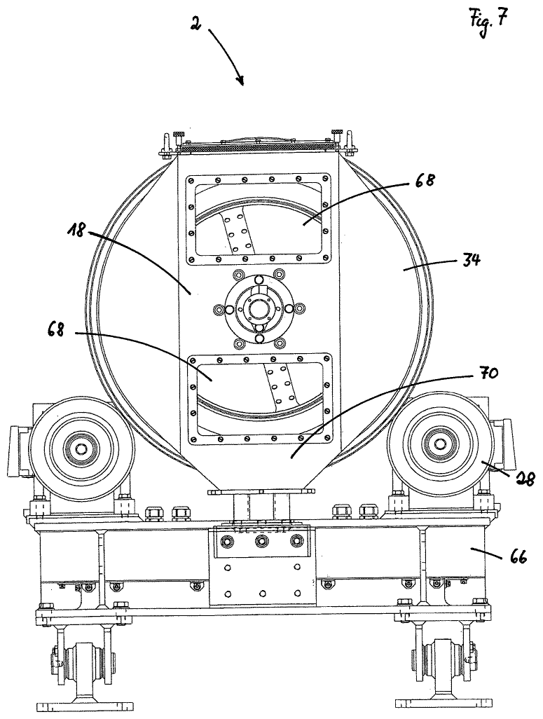

FIG. 7: a view of the discharge side of the grinding media mill; and

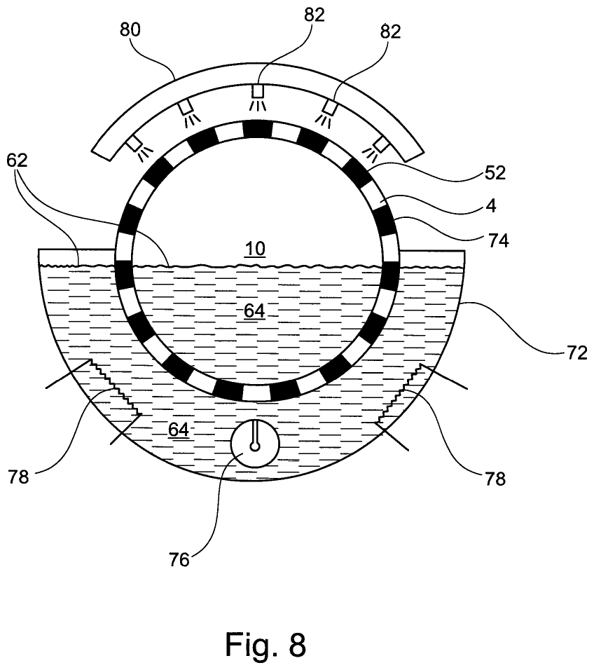

FIG. 8: a cross section view of the drum with a receiving chamber.

In FIG. 1, a side view of a grinding media mill 2 is illustrated. The grinding media mill 2 comprises a drum 4 through which a material mixture to be ground is conveyed in order to remove the natural rubber contained in a plant raw material and to agglomerate the natural rubber so that it can be removed as an agglomerate easily from the material mixture to be ground and separated therefrom.

The drum 4 is rotatably supported about an axis of rotation 6. Axis of rotation 6 can be designed as a real shaft but it can also be provided only by the type and manner of the support of the drum 4. The drum 4 is caused to rotate by the two motors 8 shown in the illustrated embodiment. Within the drum 4, there is a milling chamber 10 in which the material mixture to be ground is worked on by grinding media that are located in the milling chamber 10. The grinding media are not illustrated in the Figures.

The drum 4 comprises a first end face 12 from where the material mixture to be ground is fed into the milling chamber 10. After passing through, the material mixture to be ground exits again from the milling chamber 10 via the discharge device 18 which is located in the region of the second end face 14. The material mixture to be ground is supplied by a separate feed device 16 to the milling chamber 10 through a rotary feedthrough 20. A rotary feedthrough can also be provided in the region of the discharge device 18.

In order to be able to fill and remove again grinding media into the milling chamber 10, a number of openings 22 are provided in the wall of the drum 4. The openings 22 can be correlated with a respective section within the milling chamber 10.

In the embodiment, the drum 4 is assembled of a plurality of six pipe segments 24. Each pipe segment 24 comprises a flange surface 26 at the end face that is embodied congruent to the flange surfaces 26 of other pipe segments 24. By a simple positioning of the flange surfaces 26 against each other, arbitrary pipe segments 24 can thus be assembled to a drum 4 in an also principally arbitrary orientation. The pipe segments 24 can have different lengths along the axis of rotation 6 and diameters. The diameters of the pipe segments 24 can also vary across their length in direction of the axis of rotation 6.

In the embodiment, the drum 4 is supported at its outer circumference on rollers 28. The two rollers 28 illustrated in FIG. 1 are driven by the motors 8. In the embodiment, the rollers 28 run along the outer edges of the flange surfaces 26 so that they form a circumferential running surface.

The material mixture to be ground can be supplied to the milling chamber 10 via the feed container 30. For this purpose, the material mixture to be ground is filled from above into the feed container 30. From here, it is then supplied through the rotary feedthrough 20 to the milling chamber 10. In the embodiment, the feed container 30 comprises an additional feed conduit 32 by means of which liquids or gases can be added to the material mixture to be ground. Due to the arrangement of the feed conduit at the feed side of the drum 4, it is possible to additionally liquefy the material mixture to be ground, to loosen it, or to additionally decompose the biological raw materials when the medium conveyed through the feed conduits 32 is introduced at high pressure or at a high temperature into the feed device 16. Thus, the feed conduits 32 can supply, for example a liquid, which decomposes the cell structures of the plant raw materials by mechanical action and/or thermally, through a steam nozzle or a spray valve.

The discharge device 18 can be provided with an end wall 34 that delimits the discharge device 18.

The working processes that are performed by the grinding media mill 2 can be adjusted and controlled by a control unit 36. The control unit 36 is connected to the devices 38 by means of which the rotational speed of the drum 4 can be variably adjusted. The device 38 can be an output regulator for the motor 8. However, also other configurations for the device 38 are possible, for example, a planetary transmission or stepless transmission with which the rotational speed of the drum 4 is variably adjustable.

The control unit 36 is connected by means of corresponding connection lines 40 to the devices 38 as an example of a rotational speed control, the actor 44 as an on-off switch or rotational speed regulator for the feed device 16 as well as a camera 42 as an example of a sensor. The connection lines 40 can be realized as connection cables but there are also other connection types possible, for example, a wireless connection by radio communication, by optical waveguides, or other media for transmitting data.

In the embodiment illustrated in FIG. 1, the drum 4 is supported by a total of four rollers 28 of which the two rollers 28 illustrated in the front are driven by a motor 8, respectively. Depending on the length and weight of the drum 4, additional rollers 28 can be provided also. It is also possible to drive more or only a single roller 28 by a motor.

In FIG. 2, a section view of the drum 4 illustrated in FIG. 1 is shown. In the section view a total of six partitions 46 can be seen that divide the milling chamber 10 into seven sections 48. In each of the sections 48, grinding media can be arranged wherein the number, the weight, the shape, and the size of the grinding media can vary between the individual sections 48. The selection of the grinding media to be respectively introduced into a section 48 has an effect on the decomposition of the biological raw materials, the dissociation of the natural rubber from the biological raw materials as well as on the agglomeration of this natural rubber.

The section illustration illustrated in FIG. 2 shows that the inner surfaces 50 of the outer walls 52 are not embodied plane-parallel to the axis of rotation 6 but comprise a conical basic shape. In deviation from the embodiment, the inner surfaces can be designed, of course, also cylindrical or in other ways. By means of the setting angle of the outer walls 52 or of the inner surfaces 50 relative to the axis of rotation 6, it is possible to affect as a whole the flow rate of the material mixture to be ground through the sections 48 and the milling chamber 10. While the wall with the inner surface 50 of the first pipe segment 24, comprises a setting angle relative to the axis of rotation 6 of 85 degrees, the inner surface 50 of the second pipe segment 24 is positioned at a setting angle of 79.5 degrees. Of course, also setting angles deviating therefrom can be selected. Also other non-cylindrical basic shapes of the pipe segments 24 can be selected. The pipe segments 24 have in this context a suitable length in order to be able to perform a suitable processing of the plant raw materials in the corresponding section 48. The number, the length, the diameter, the shape of the pipe segments that are assembled to a drum 4 can be suitably designed and selected by a person of skill in the art.

The flange surfaces 26 of the pipe segments 24 can be connected to each other by connection elements such as, for example, a number of screws with lock nuts or stud bolts.

In the section illustration of FIG. 2, it can be seen well that the milling chamber 10 comprises a conically tapering constriction toward the discharge device 18 in the region of the second end face 14 and thus at its end positioned downstream. The illustrated constriction is well suited to skim off the flakes of agglomerated natural rubber floating up to the surface of the material mixture to be ground. The discharge can be realized in that either a material mixture to be ground is increasingly supplied to the milling chamber 10 whereby a flushing impulse in the milling chamber 10 is generated and/or the axis of rotation 6 of the drum 4 at the feed side end is lifted and/or lowered at the discharge-side end, whereby then the flakes are flushed out of the milling chamber 10 without in this context higher proportions of the remainder of the plant raw materials being flushed out. The fraction of the material mixture to be ground that no longer contains noteworthy quantities of natural rubber can subsequently be discharged from the last section 48, wherein then the respective fractions can be separated by the discharge device 18 in that they are conveyed into different discharge containers. It is of course also possible to discharge the material mixture to be ground as a whole from the milling chamber 10 without separately skimming off the agglomerated natural rubber by means of the grinding media mill 2.

FIG. 3 shows an enlarged section view of the feed device 16. For supplying the material mixture to be ground, the feed device 16 comprises a connection socket 54 to which the feed container 30 can be connected. In the region of the connection socket 54, there is also the feed conduit 32. In the feed device 16, there is a screw conveyor as a drivable forced feed action 56 which passes through the rotary feedthrough 20 and conveys material mixture to be ground supplied by the connection socket 54 into the milling chamber 10. The augers of the screw conveyor force the plant raw materials reliably into the milling chamber 10. They prevent at the same time that grinding media that are moved upon rotation of the drum 4 in the milling chamber 10 can pass into the feed device 16. Also, a return flow of the material mixture to be ground into the feed device 16 is prevented by the forced feed action 56. The forced feed action 56 is arranged coaxial to the axis of rotation 6 of the drum 4.

FIG. 4 shows a grinding media mill 2 in which the axis of rotation 6 of the drum 4 is lifted relative to the horizontal W. Since in this way also the inner surfaces 50 of the pipe segments 24 ascend in the conveying direction along the axis of rotation 6 toward the right relative to the horizontal W, the conveying speed with which the material mixture to be ground flows through the milling chamber 10 is naturally reduced in such an angle position of the drum 4. In reverse, it is conceivable that, for an angle position of the axis of rotation 6 in which the latter descends in conveying direction relative to the horizontal, the conveying speed of the material mixture to be ground through the milling chamber 10 is increased. In the embodiment, the drum 4 is held on a frame that, in turn, is supported by rotary bearings on the ground. For changing the spatial position of the axis of rotation 6, mechanical adjusting means can be provided but it is also possible to lift or lower the frame at one or both sides by motor-driven actuators such as, for example, a lifting cylinder.

In FIG. 5, an end face view of a partition 46 is illustrated. The partition 46 comprises a number of passage openings 58 through which the material mixture to be ground can flow from one section 48 to the neighboring downstream section 48. In the embodiment illustrated in FIG. 5, the passage openings 58a, 58b, and 58c have different shapes and sizes. While the passage openings 58a in regard to their shape and size are sized such that they retain the grinding media contained in a section, the passage openings 58b are sized in regard to their shape and size such that through them grinding media can also pass into a neighboring section.

The partition 46 illustrated in FIG. 5 has the passage opening 58c embodied as a cutout 60 whose radius R₁ in at least one part of the circular arc covered by the cutout 60 is larger than the outer circumference of the axis of rotation 6 determined by the radius R₂ in the region of the corresponding partition 46. In the embodiment illustrated in FIG. 5 of a partition 45, the cutout 60 is provided with a grid in order to avoid passage of grinding media. When however the grid illustrated in FIG. 5, in deviation from the embodiment, is omitted, it is possible to move sensors 42 along the axis of rotation 6 through one or a plurality of sections 48. In FIG. 5, it can be seen that the camera as sensor 42 is arranged adjacent to the axis of rotation 6 in the milling chamber 10. In case of a fill of the milling chamber 10 with material mixture to be ground 64, indicated by the wavy line 62, the sensor 42 is arranged at a distance to the material mixture to be ground 64 at which damage or soiling of the sensor 42 is hardly probable.

In FIG. 6, a view of the feed side of the grinding media mill 2 is illustrated. In this view, the round circumferential shape of the drum 4 can be seen well. Also, the feed device 16 with the funnel-shaped feed container 30, the connection socket 54 arranged underneath, as well as the plurality of feed conduits 32 can be seen. In the end view, the axis of rotation 6 can be seen also wherein the axis of rotation 6 here illustrates the rotary bearing of the forced feed action 56 that is driven by a separate motor 8. In this view, it can also be seen well that the drum 4 is held by the rollers on the frame 66.

In FIG. 7, a view of the discharge side of the grinding media mill 2 is illustrated. In this view, the control ports 68 can be seen that are provided in the end wall 34 in order to be able to visually check through the control ports whether the natural rubber contained in the biological raw materials has agglomerated to flakes in the last section 48 of the milling chamber 10.

The material mixture to be ground 64 discharged through the discharge device 18 from the milling chamber 10 can be further conveyed via a discharge socket 70 to downstream separating and cleaning devices.

In FIG. 8, a cross section view of a drum 4 with a receiving chamber 72 is illustrated. The outer wall 52 of the drum 4 in the embodiment is designed as a perforated metal plate so that the material mixture to be ground 64 can pass from the milling chamber 10 in the interior of the drum 4 through the openings 74 in the perforated metal plate outwardly into the receiving chamber 72. The openings 74 can be designed such that grinding media from the milling chamber 10 can pass through them into the receiving chamber 72, or they are designed such that this is prevented. The receiving chamber 72 can be utilized to wash, to boil the plant raw material contained in the material mixture to be ground 64 and/or to separate and discharge components of the material mixture to be ground 64. For this purpose, corresponding process tools can be arranged in the receiving chamber 72. In the embodiment, a screw conveyor 76 is illustrated with which the sediment that collects at the bottom of the receiving chamber 72 can be discharged. Furthermore, heaters 78 are illustrated with which the material mixture to be ground 64 can be heated, for example, in order to boil it.

Above the drum 4, there is furthermore a jacket 80 illustrated in FIG. 8 which surrounds the circumference of the drum 4 partially and at which nozzles 82 are arranged. By means of the nozzles 82, a liquid, a gas or hot steam can be injected into the milling chamber 10 from the exterior through the openings 74 in the outer wall 52 of the drum 4. In the jacket 80, also metering means for adding solids into the milling chamber can be provided, which solids are added to the material mixture to be ground in order to assist in dissociation and separation of the polyisoprenes and other apolar materials that are released upon processing.

The invention is not limited to the afore described embodiments. A person of skill in the art will have no difficulties in modifying the embodiments in a manner appearing suitable to him in order to adapt it to a concrete application case.

What is claimed is:

1-20. (canceled)

21. A grinding media mill for obtaining polyisoprene and/or other apolar materials from plant raw materials, the grinding media mill comprising:
a motor;
a peripherally closed drum, configured to be driven in rotation about an axis of rotation by the motor;
the peripherally closed drum comprising a peripherally closed milling chamber located in an interior of the peripherally closed drum and configured to receive grinding media;
a feed device arranged at a first end of the peripherally closed drum and configured to feed a material mixture to be ground, comprised of solids and a liquid, into the peripherally closed drum through a rotary feedthrough;
a discharge device arranged at a second end of the peripherally closed drum opposite the first end, the discharge device configured to discharge the material mixture to be ground that has been processed in the peripherally closed milling chamber from the peripherally closed drum;
the peripherally closed milling chamber divided along the axis of rotation into sections by partitions arranged transversely to the axis of rotation in the interior of the peripherally closed drum, wherein the partitions comprise passage openings through which the material mixture to be ground can pass from one of the sections into a neighboring one of the sections, respectively;
wherein the passage openings are dimensioned to retain the grinding media in the sections, respectively; and
wherein the motor comprises a device configured to variably adjusted a rotational speed of the peripherally closed drum.

22. The grinding media mill according to claim 21, wherein at least one of the partitions comprises a cutout arranged in a region around the axis of rotation, wherein the cutout comprises a radius in at least one part of a circular arc covered by the cutout, wherein the radius of the cutout is larger than a radius of the axis of rotation in a region of said at least one partition.

23. The grinding media mill according to claim 21, wherein the sections of the peripherally closed drum each comprise an outer wall and wherein the outer wall of at least one of the sections comprises an opening permeable for the material mixture to be ground, wherein the opening is adjoined in a radially outward direction of said at least one section by a closed receiving chamber, wherein process tools are arranged in the receiving chamber.

24. The grinding media mill according to claim 21, wherein the sections among each other are furnished with a different quantity of grinding media and/or with grinding media of different sizes.

25. The grinding media mill according to claim 21, wherein at least one of the sections comprises feed and removal openings configured to supply grinding media and/or to remove grinding media.

26. The grinding media mill according to claim 21, wherein the feed device comprises a drivable forced feed action arranged in front of the rotary feedthrough and/or in the rotary feedthrough.

27. The grinding media mill according to claim 26, wherein the forced feed action is arranged coaxially to the axis of rotation of the peripherally closed drum.

28. The grinding media mill according to claim 21, wherein the axis of rotation of the peripherally closed drum is angularly positioned relative to the horizontal.

29. The grinding media mill according to claim 21, wherein an inner surface of at least one of the sections comprises no cylindrical basic shape.

30. The grinding media mill according to claim 21, wherein the peripherally closed drum comprises pipe segments connected to each other along the axis of rotation of the peripherally closed drum.

31. The grinding media mill according to claim 30, wherein the pipe segments comprise flange surfaces, wherein the flange surfaces are congruent to each other and are connected to each other by connection elements.

32. The grinding media mill according to claim 21, further comprising four or more rollers, wherein at least one of the four or more rollers is motor-driven, wherein the peripherally closed drum is supported on the four or more rollers.

33. The grinding media mill according to claim 21, further comprising a feed container, wherein the feed container is configured to meter the material mixture to be ground or a part of the material mixture to be ground to the feed device.

34. The grinding media mill according to claim 33, further comprising a feed conduit connected to the feed device and/or connected to the feed container, wherein the feed conduit is configured to meter liquid and/or gaseous substances into the feed device and/or into the feed container.

35. The grinding media mill according to claim 21, further comprising:
an electronic control unit connected to the device configured to variably adjusted a rotational speed of the peripherally closed drum;
sensors connected to the electronic control unit and configured to detect process-technological parameters of the grinding media mill and transmit sensor signals of the process-technological parameters to the electronic control unit;
actors configured to change the process-technological parameters of the grinding media mill;
wherein the electronic control unit comprises software configured to evaluate the sensor signals and wherein the electronic control unit is configured to control the actors as a function of the evaluation of the sensor signals by the software and/or by manual operating inputs of an operator.

36. The grinding media mill according to claim 35, wherein the sensors include at least one sensor arranged in the peripherally closed milling chamber for process monitoring.

37. The grinding media mill according to claim 36, wherein said at least one sensor is arranged in the peripherally closed milling chamber adjacent to the axis of rotation.

38. The grinding media mill according to claim 21, wherein an end wall of the peripherally closed drum arranged at the second end of the peripherally closed drum comprises control ports.

39. The grinding media mill according to claim 21, wherein the peripherally closed milling chamber comprises a conically tapering constriction at the second end of the peripherally closed drum.

40. A method for obtaining natural rubber from biological raw materials, wherein the method comprises:
extracting the natural rubber in the grinding media mill according to claim 1 and agglomerating the natural rubber in the peripherally closed drum by driving the peripherally closed drum in rotation.
